(19) United States
(12) Patent Application Publication
(10) Pub. No.: US 2014/0080948 A1
(43) Pub. Date: Mar. 20, 2014

(54) POLYMER-ADDITIVE CARRIER COMPOSITION

(71) Applicant: Dover Chemical Corporation, Dover, OH (US)

(72) Inventors: Don STEVENSON, Dover, OH (US); Jacob LANCE, New Philadelphia, OH (US); Michael Jakupca, Canton, OH (US)

(73) Assignee: Dover Chemical Corporation, Dover, OH (US)

(21) Appl. No.: 14/027,660

(22) Filed: Sep. 16, 2013

Related U.S. Application Data
(60) Provisional application No. 61/701,142, filed on Sep. 14, 2012.

(51) Int. Cl. C08L 67/00; C08K 5/527

(52) U.S. Cl. CPC C08L 67/00; C08K 5/527
USPC 524/120

(57) ABSTRACT

A composition having a polymeric ester having the formula:

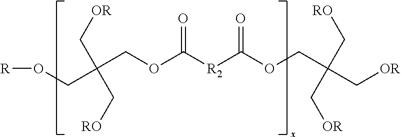

wherein each R is the same or different and independently selected from the group consisting of H, C₁₋₂₀ alkyl carboxylate, C₃₋₂₂ alkenyl carboxylate, C₆₋₄₀ cycloalkyl carboxylate, and C₆₋₄₀ cycloalkylene carboxylate; R₂ is selected from the group consisting of C₁₋₂₀ alkyl, C₃₋₂₂ alkenyl, C₆₋₄₀ cycloalkyl, and C₆₋₄₀ cycloalkylene; and at least one polymer additive.

### CROSS-REFERENCE TO RELATED APPLICATIONS

This utility patent application claims priority to U.S. provisional patent application 61/701,142 having a filing date of Sep. 14, 2012. The Ser. No. 61/701,142 application's subject matter is incorporated into this application by reference.

### BACKGROUND OF THE INVENTION

Polymer stabilizers are well known for increasing the quality and durability of polymeric materials and products. At least one purpose associated with using polymer stabilizers is to inhibit polymer deterioration during processing at high temperatures and also to enable manufacturing better quality products because of increased thermal resistance and reduced light degradation during their intended use.

Stabilizers vary greatly in physical properties with some being very low viscosity liquids and others being solids with melt points of more than several-hundred-degrees centigrade. This creates a problem in industry because most equipment designed to handle these additives can only handle either solids or liquids but not both. Equipment design can therefore limit the types of liquid or solid additives that manufactures can use.

A need remains for a way to introduce both liquid and solid polymer additives into equipment that is designed to handle either solids or liquids but not both.

### BRIEF SUMMARY OF THE INVENTION

A composition having a polymeric ester having the formula:

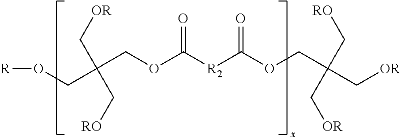

wherein
each R is the same or different and independently selected from the group consisting of H, C₁₋₂₀ alkyl carboxylate, C₃₋₂₂ alkenyl carboxylate, C₆₋₄₀ cycloalkyl carboxylate, and C₆₋₄₀ cycloalkylene carboxylate;
R₂ is selected from the group consisting of C₁₋₂₀ alkyl, C₃₋₂₂ alkenyl, C₆₋₄₀ cycloalkyl, and C₆₋₄₀ cycloalkylene; and
   at least one polymer additive.

A composition having a first component, a second component, and a third component;

the first component is a polymeric ester having the formula:

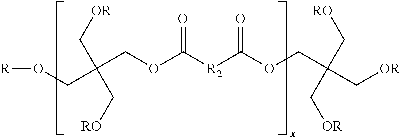

wherein
each R is the same or different and independently selected from the group consisting of H, C₁₋₂₀ alkyl carboxylate, C₃₋₂₂ alkenyl carboxylate, C₆₋₄₀ cycloalkyl carboxylate, and C₆₋₄₀ cycloalkylene carboxylate;
R₂ is selected from the group consisting of C₁₋₂₀ alkyl, C₃₋₂₂ alkenyl, C₆₋₄₀ cycloalkyl, and C₆₋₄₀ cycloalkylene; and
   the second component is at least one polymer additive.

A composition comprising:

a first component, a second component, and a third component;

the first component is a polymeric ester having the formula:

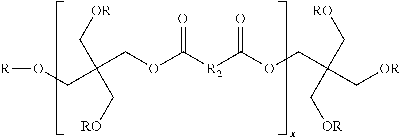

wherein
each R is the same or different and independently selected from the group consisting of H, C₁₋₂₀ alkyl carboxylate, C₃₋₂₂ alkenyl carboxylate, C₆₋₄₀ cycloalkyl carboxylate, and C₆₋₄₀ cycloalkylene carboxylate;
R₂ is selected from the group consisting of C₁₋₂₀ alkyl, C₃₋₂₂ alkenyl, C₆₋₄₀ cycloalkyl, and C₆₋₄₀ cycloalkylene; and
   the second component is selected from the group consisting of an oligomeric phosphite; a polymeric phosphite; and a combination thereof.

### BRIEF DESCRIPTION OF THE SEVERAL VIEWS OF THE DRAWINGS

FIG. 1 shows a multi-pass extrusion was run to compare the performance of the bis (dicumylphenyl) penterythritol diphosphite, with the blend of bis (dicumylphenyl) penterythritol diphosphite and a polymeric pentearythritol ester of Example 1. Both were compounded and then extruded 5 times with Melt Flow and Color measured on the 1^{st}, 3^{rd}, and 5^{th} passes. The formulation (i.e., carrier composition) containing the bis (dicumylphenyl) pentraerythritol diphosphite gave nearly identical performance with respects to Melt Flow and showed a much improved performance with respect to color.

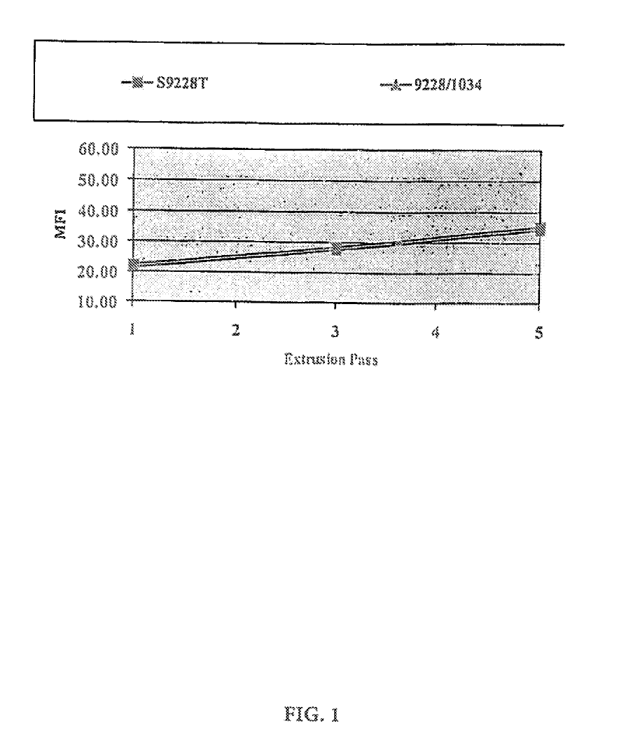

### DETAILED DESCRIPTION OF THE INVENTION

Embodiments are directed to a polymeric-ester-based carrier composition that facilitates introducing both solid and liquid polymer additives into a polymer matrix. The carrier composition is made up of a polymeric-ester carrier compound that is loaded with at least one polymer additive; the carrier composition (i.e., the carrier compound loaded with the at least one polymer additive) can be introduced into a polymer matrix. By using the polymeric-ester(s) as a carrier compound, liquid stabilizers can be set up as a solid carrier composition(s) (i.e., within a solid polymeric-ester carrier), and solid stabilizers can be made into low-melting liquid dispersions (within a liquid polymeric-ester carrier). Stated differently, in embodiments, the polymeric-ester carrier has a liquid-solid phase transition point that allows the carrier to be easily manipulated into a liquid or solid carrier composition depending on the need. This phase-change manipulation allows the stabilizers to be used either as solids or liquids depending on whether the equipment is designed to receive a solid or liquid.

In embodiments, the polymeric esters, when blended with a liquid additive, can make a solid carrier composition. In other embodiments, low-melting versions of the polymeric ester can be used as a liquid carrier and dispersant for solid polymer additives.

In embodiments, charging the solid-phase carrier can be done by melting the polymeric ester (above its melting point) and then mixing an additive, e.g., a solid phosphite. The mixture can then be poured onto a flaker belt to solidify. In other embodiments, charging the liquid-phase carrier can be done simply by mixing in an additive at a temperature above the polymeric ester's melting point.

Embodiments are directed to using at least one of the polymeric esters of Structure 1 as a carrier for polymer additives.

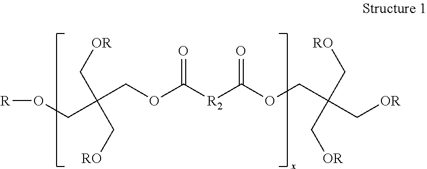

wherein
each R is the same or different and independently selected from the group consisting of H, C_{1- 20} alkyl carboxylate, C₃₋₂₂ alkenyl carboxylate, C₆₋₄₀ cycloalkyl carboxylate, and C₆₋₄₀ cycloalkylene carboxylate; and
R₂ is selected from the group consisting of C₁₋₂₀ alkyl, C₃₋₂₂ alkenyl, C₆₋₄₀ cycloalkyl, and C₆₋₄₀ cycloalkylene.

Polymeric esters having the chemical structure shown in Structure 1 can be manufactured using known methods by persons of ordinary skill in the art without having to exercise undue experimentation.

The polymeric esters of Structure 1 can be combined or loaded with polymer additives known in the art including:

Hindered phenolic antioxidants such as 2,6-di-tert-butyl-4-methylphenol; octadecyl 3,5-di-tert-butyl-4-hydroxy-hydrocinnamate; tetrakis methylene (3,5-di-tert-butyl-4-hydroxyhydrocinnamate)methane; and tris(3,5-di-tert-butyl-4-hydroxybenzyl) isocyanate. Other phenolic antioxidants are listed in Chemical Additives, pages 152 to 163.

Thioesters such as dilauryl thiodipropionate and distearyl thiodipropionate. Other thioesters are listed in Chemical Additives, page 152 to 163.

Aromatic amine stabilizers such as N, N′-diphenyl-p-phenylene-diamine. Other aromatic amine stabilizers are listed in Chemical Additives, pages 152 to 163.

Hindered amine light stabilizers, known as HALS, such as bis-(2,2,6,6-tetramethylpiperidyl) sebacate, condensation product of N,N′-(2,2,6.6-tetramethylpiperidyl)-hexamethylenediamine and 4,4-octylamino-2,6-dichloro-s-triazine, and the condensation product of N,N′-(2,2,6.6-tetramethylpiperidyl)-hexamethylenediamine and 4-N-morpholinyl-2,6-dichloro-s-triazine. Other HALS are listed in Chemical Additives, pages 660-666.

UV absorbers such as 2-hydroxy-4-n-octyloxybenzophenone, 2(2′-hydroxy-5′-methylphenyl)-benzotriazole, and 2(2′-hydroxy-5-t-octylphenyl)-benzotriazole. Other UV stabilizers are listed in Chemical Additives, pages 660-666.

Phosphites such as tris(2,4-di-tert-butylphenyl)phosphite, distearyl pentaerythritol diphosphite, and 2,4-dicumylphenyl pentaerythritol diphosphite. Other phosphites are listed in Chemical Additives, pages 152 to 163. Also included are oligomeric phosphites and polymeric phosphites.

Acid neutralizers such as calcium stearate, zinc stearate, calcium lactate, calcium stearyl lactate, epoxidized soybean oil, and hydrotalcite (natural and synthetic).

Useful concentrations of the additive(s) within the carrier compound can be discovered by a person of ordinary skill in the art without having to exercise undue experimentation.

### EXAMPLES

### Example 1

### Synthesis of Polymeric Ester

To a three-necked flask equipped with a mechanical stirring device and a nitrogen adapter was charged 560 g (1.97 mol) of molten stearic acid, 120 g of pentearythritol, 112 g of adipic acid, and 0.8 g of tin oxalate. These were heated to 220 C under a light nitrogen sweep. As the temperature approached 200 C water began to boil out of the reaction. The reaction was heated for 5 hrs at which point no more water was being removed. The reaction was cooled and it solidified. The product had a melting point of about 50 C.

### Example 2

A blend of the ester in Example 1 and a solid phosphite, i.e., bis (dicumylphenyl) penterythritol diphosphite, was made. To make the blend the ester was heated above its melt point and an equal amount of the bis (dicumylphenyl) penterythritol diphosphite was charged. The blend could be kept liquid at around 50 C which would allow it to be loaded into a polymer using a liquid feeding system or it could be cooled to below 50 C and charged as a solid.

A multi-pass extrusion was run to compare the performance of the bis (dicumylphenyl) penterythritol diphosphite, with the blend of bis (dicumylphenyl) penterythritol diphosphite and a polymeric pentearythritol ester of Example 1. Both were compounded and then extruded 5 times with Melt Flow and Color measured on the 1^{st}, 3^{rd}, and 5^{th} passes. The formulation (i.e., carrier composition) containing the bis (dicumylphenyl) pentraerythritol diphosphite gave nearly identical performance with respects to Melt Flow and showed a much improved performance with respect to color.

### Formulations:

| Material | A | B |
|---|---|---|
| Profax 6301NT | X | X |
| (PP) | | |
| Calicum Stearate | 500 | 500 |
| Hindered phenolic | 500 | 500 |
| 1010 | | |
| Solid phosphite | 1000 | |
| AA | | |
| Solid phosphite | | 2000 |
| AA in Polyester A | | |

### Color Measurements: Melt Flow Stability MFI

| | YI |
|---|---|
| A1 | 18.12 |
| A3 | 26.42 |
| A5 | 32.02 |
| B1 | 16.63 |
| B3 | 21.01 |
| B5 | 25.08 |

### Melt Flow Flow Stability MFI:

| | MFI |
|---|---|
| A1 | 22 |
| A3 | 27 |
| A5 | 35 |
| B1 | 21 |
| B3 | 24 |
| B5 | 33 |

### Example 3

The ester of example 1 was melted and mixed 50/50 with liquid polymeric phosphite. The product was thoroughly mixed and then cooled to form a soft solid.

What is claimed is:

1. A composition comprising:
a polymeric ester having the formula: 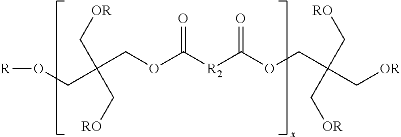
wherein
each R is the same or different and independently selected from the group consisting of H, C₁₋₂₀ alkyl carboxylate, C₃₋₂₂ alkenyl carboxylate, C₆₋₄₀ cycloalkyl carboxylate, and C₆₋₄₀ cycloalkylene carboxylate;
R₂ is selected from the group consisting of C₁₋₂₀ alkyl, C₃₋₂₂ alkenyl, C₆₋₄₀ cycloalkyl, and C₆₋₄₀ cycloalkylene; and
at least one polymer additive.

2. The composition of claim 1, wherein the at least one polymer additive is selected from the group consisting of a hindered phenolic antioxidant; a phenolic antioxidant; a thioester; an aromatic amine stabilizer; a hindered amine light stabilizer; a UV absorber; a UV stabilizer; a phosphite; an acid neutralizer; and a combination thereof.

3. The composition of claim 1, wherein the at least one polymer additive is selected from the group consisting of 2,6-di-tert-butyl-4-methylphenol; octadecyl 3,5-di-tert-butyl-4-hydroxy-hydrocinnamate; tetrakis methylene (3,5-di-tert-butyl-4-hydroxyhydrocinnamate)methane; tris(3,5-di-tert-butyl-4-hydroxybenzyl) isocyanate; a thioester; dilauryl thiodipropionate; distearyl thiodipropionate; N, N′-diphenyl-p-phenylene-diamine; bis-(2,2,6,6-tetramethylpiperidyl) sebacate, a condensation product of N,N′-(2,2,6.6-tetramethylpiperidyl)-hexamethylenediamine and 4,4-octylamino-2,6-dichloro-s-triazine; a condensation product of N,N′-(2,2,6.6-tetramethylpiperidyl)-hexamethylenediamine and 4-N-morpholinyl-2,6-dichloro-s-triazine; 2-hydroxy-4-n-octyloxybenzophenone; 2(2′-hydroxy-5′-methylphenyl)-benzotriazole; 2(2′-hydroxy-5-t-octylphenyl)-benzotriazole; tris(2,4-di-tert-butylphenyl)phosphite; distearyl pentaerythritol diphosphite; 2,4-dicumylphenyl pentaerythritol diphosphite; calcium stearate; zinc stearate; calcium lactate; calcium stearyl lactate; epoxidized soybean oil; natural hydrotalcite; synthetic hydrotalcite; and a combination thereof.

4. The composition of claim 1, wherein the at least one polymer additive is selected from the group consisting of oligomeric phosphites; polymeric phosphites; and a combination thereof.

5. The composition of claim 4, wherein the polymeric ester is in the liquid phase.

6. A composition comprising:
a first component, a second component, and a third component;
the first component is a polymeric ester having the formula: 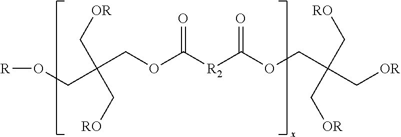
wherein
each R is the same or different and independently selected from the group consisting of H, C₁₋₂₀ alkyl carboxylate, C₃₋₂₂ alkenyl carboxylate, C₆₋₄₀ cycloalkyl carboxylate, and C₆₋₄₀ cycloalkylene carboxylate;
R₂ is selected from the group consisting of C₁₋₂₀ alkyl, C₃₋₂₂ alkenyl, C₆₋₄₀ cycloalkyl, and C₆₋₄₀ cycloalkylene; and
the second component is at least one polymer additive.

7. The composition of claim 6, wherein the at least one polymer additive is selected from the group consisting of a hindered phenolic antioxidant; a phenolic antioxidant; a thioester; an aromatic amine stabilizer; a hindered amine light stabilizer; a UV absorber; a UV stabilizer; a phosphite; an acid neutralizer; and a combination thereof.

8. The composition of claim 6, wherein the at least one polymer additive is selected from the group consisting of 2,6-di-tert-butyl-4-methylphenol; octadecyl 3,5-di-tert-butyl-4-hydroxy-hydrocinnamate; tetrakis methylene (3,5-di-tert-butyl-4-hydroxyhydrocinnamate)methane; tris(3,5-di-tert-butyl-4-hydroxybenzyl) isocyanate; a thioester; dilauryl thiodipropionate; distearyl thiodipropionate; N,N′-diphenyl-p-phenylene-diamine; bis-(2,2,6,6-tetramethylpiperidyl) sebacate, a condensation product of N,N′-(2,2,6.6-tetramethylpiperidyl)-hexamethylenediamine and 4,4-octylamino-2,6-dichloro-s-triazine; a condensation product of N,N′-(2,2,6.6-tetramethylpiperidyl)-hexamethylenediamine and 4-N-morpholinyl-2,6-dichloro-s-triazine; 2-hydroxy-4-n-octyloxybenzophenone; 2(2′-hydroxy-5′-methylphenyl)-benzotriazole; 2(2′-hydroxy-5-t-octylphenyl)-benzotriazole; tris(2,4-di-tert-butylphenyl)phosphite; distearyl pentaerythritol diphosphite; 2,4-dicumylphenyl pentaerythritol diphosphite; calcium stearate; zinc stearate; calcium lactate; calcium stearyl lactate; epoxidized soybean oil; natural hydrotalcite; synthetic hydrotalcite; and a combination thereof.

9. The composition of claim 6, wherein the at least one polymer additive is selected from the group consisting of an oligomeric phosphite; a polymeric phosphite; and a combination thereof.

10. The composition of claim 6, wherein the third component is a polymer.

11. A composition comprising:
a first component, a second component, and a third component;
the first component is a polymeric ester having the formula: 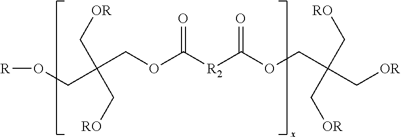
wherein
each R is the same or different and independently selected from the group consisting of H, C₁₋₂₀ alkyl carboxylate, C₃₋₂₂ alkenyl carboxylate, C₆₋₄₀ cycloalkyl carboxylate, and C₆₋₄₀ cycloalkylene carboxylate;
R₂ is selected from the group consisting of C₁₋₂₀ alkyl, C₃₋₂₂ alkenyl, C₆₋₄₀ cycloalkyl, and C₆₋₄₀ cycloalkylene; and
the second component is selected from the group consisting of an oligomeric phosphite; a polymeric phosphite; and a combination thereof.

12. The composition of claim 11, wherein the third component is a polymer.
